(19) United States
(12) Patent Application Publication
(10) Pub. No.: US 2026/0024015 A1
(43) Pub. Date: Jan. 22, 2026

(54) TECHNIQUE OF CATEGORISATION OF BINARY EXECUTABLE FILES AND TRAINING METHOD OF AN ELECTRONIC CONTROL UNIT FOR VEHICLES USING THE TECHNIQUE

(71) Applicant: MAGICMOTORSPORT S.R.L., Partinico (IT)

(72) Inventor: Grzegorz OWSIANY, Partinico (IT)

(73) Assignee: MAGICMOTORSPORT S.R.L., Partinico, PA (IT)

(21) Appl. No.: 18/998,829

(22) PCT Filed: Jul. 27, 2023
(86) PCT No.: PCT/IB2023/057616

§ 371 Date: Jan. 27, 2025

(30) Foreign Application Priority Data
Jul. 27, 2022 (IT) 102022000015861

(51) Int. Cl. G06N 20/00

(52) U.S. Cl. CPC G06N 20/00

(57) ABSTRACT

A technique of categorization of binary executable files comprising the following steps:
a) a starting step of analysis of input and training data for containing semi-organized, partially monotonic sequences;
b) a preprocessing step wherein potential sequences are discarded or accepted on the basis of preset statistical criteria;
c) an encoding step of said accepted sequences with metadata;
d) a storing step of the encoded sequences, wherein said sequences are stored as part of the data sequences digest containing information describing the spatial organization of the sequences, the monotonicity features thereof and other features valuable for approximate matching;
e) a computing step of locality-sensitive hashes corresponding to said input and training data files.

### DESCRIPTION

### Technical Field

The present invention find application in the technical field of electric digital data processing and particularly relates with a technique of categorization of binary executable files. The invention finds specific but not exclusive application in the automotive sector for the creation of self-learning electronic control units (ECU) for vehicles equipped with artificial intelligence systems using the above technique in accordance with the present invention for the purpose of their training.

### State of the Art

As known, binary files are regular files comprising information adapted to be read by a processor and which, in the event that they also contain machine code that have to be executed by the computer, are also defined as executable files, i.e. files suitable for instructing a system to carry out preset operations.

Efficient classification or categorization and analysis of data in binary files has increasing importance in several fields, as the amount of data in binary files continues to increase, data types continue to increase, and hybrid storage structure becomes more and more complex.

The initial stage of the input file classification process comprises the step of definition of the type thereof, data organization, architecture, or other features such as a CPU brand/model for the executable files.

However, the main drawback of the known techniques is that the preparation of specific datasets of characteristic patterns for each category is a complex and time-consuming process.

Furthermore, trimmed or incomplete binary files without specific markers are not usable for classical approaches.

Last but not least, classification based solely on characteristic patterns is prone to mislabeling due to the inclusion of misleading data sequences in the input data.

A potential application of binary file classification techniques, in the automotive sector, involves the creation of self-learning electronic control units (ECU) for vehicles.

In fact, in this field there is a constant need for tools used for diagnostics, firmware analysis and tuning that could benefit from sophisticated algorithmic and AI/ML solutions for different purposes, such as, by way of example and not restrictive:
Identification of the potential map region;
Map categorization;
Map classification;
Identification of modified regions;
ECU variant identification;
Identification of engine power variant;
Auto patching;
Auto tuning.

Therefore, there is a need for solutions that allow the creation of self-learning electronic control units (ECU) for vehicles and that use AI/ML solutions for data analysis and processing.

### SCOPE OF THE INVENTION

The object of the present invention is to provide an improved technique for categorization of executable binary files characterized by high efficiency and relative cost-effectiveness.

A main object of the present invention is to speed up categorization processes using a technique based on similarity with the training data set elements.

A further object is to provide a technique adapted to be used in the automotive sector for the management of vehicle electronic control units (ECU) and their instruction using artificial intelligence (AI) and machine learning (ML) algorithms for the analysis of software functions present within the control unit itself in order to adequately understand the main functions of the control unit, collecting information relating to the content of the memory maps, i.e. matrices whose contents vary depending on the matrix of interest, for their re-programming in order to facilitate the tuning work.

Yet another object is to create a self-learning electronic control unit (ECU) for vehicles that uses efficient AI and ML algorithms.

These objects, as well as others that will become more apparent hereinafter, are achieved by a categorization technique of executable binary files according to claim 1, as well as a method of training a control unit according to claim 8.

Advantageous embodiments of the invention are obtained in accordance with the dependent claims.

### BRIEF DISCLOSURE OF THE DRAWINGS

Further features and advantages of the invention will become more apparent in the light of the detailed description of preferred but not exclusive embodiments of the technique according to the invention, shown by way of non-limiting example with the aid of the attached drawing tables wherein:

FIG. 1 is a diagram showing a first series of steps of the technique;

FIG. 2 is a diagram showing a second series of steps of the technique;

FIG. 3 is a diagram showing a third series of steps of the technique.

### BEST MODE OF CARRYING OUT THE INVENTION

The present invention refers to a new technique for categorization of executable binary files, in particular input data files based on locality-sensitive hashes.

The invention also provides a new method of fuzzy subsequence matching, based on locality-sensitive hash wherein a new locality-sensitive hash is provided for data containing organized, partially monotone sequences.

In addition to traditional techniques based for example on the Jaccard index of characteristic patterns (markers), the proposed technique involves the following steps. Fundamentally, the technique includes a first set of steps to prepare one or more sequences of data digests, a second set of steps for calculating locality-sensitive hashes and a final set of steps for reducing plausible matches.

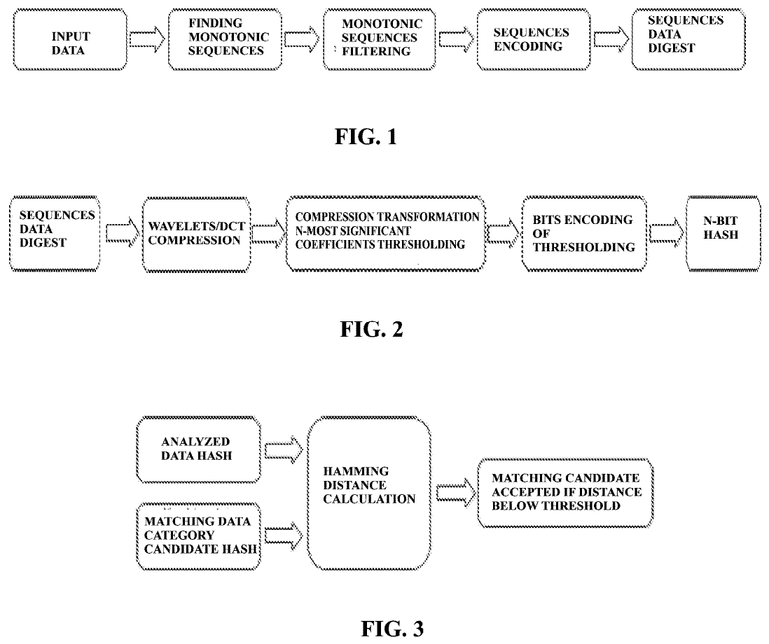

FIG. 1 shows the first set of steps to prepare the sequence data digest.

As an initial step, the input and training data are analyzed to find semi-organized and partially monotone sequences.

These sequences are common in binary files in lookup tables, dictionaries, dataset indexes.

Their relative positions, length, and other traits can be used to calculate similarity.

During the preprocessing step, potential sequences are discarded or accepted based on different statistical criteria.

Each accepted sequence is then encoded with metadata and stored as part of the sequence data digest containing information describing the spatial organization of the sequences, their monotonicity properties, and other features valuable for approximate matching.

The corresponding locality-sensitive hashes are calculated for the input and training data files, as shown in the diagram of FIG. 2.

In particular, the proprietary locality-sensitive hash is calculated based on wavelets or other similar data compression methods.

The most significant parameters of data compression are encoded with individual bits. Such an approach reduces the data digest to a 64-bit hash which is convenient for fast computation of the Hamming distance.

Similar files with the same structure have hashes that differ only by a small number of bits.

A process of reducing plausible matches is then carried out, as per the diagram of FIG. 3, using filters based on a Hamming distance threshold between the hashes.

Finally, potential collisions are resolved with the use of an edit distance of the digest data sequences.

According to a preferred but not exclusive application, a technique according to the present invention can be used within a training process of an electronic control unit for vehicles, in particular motor vehicles, commonly defined as ECU (Engine Control Unit) for the use of AI/ML algorithms.

A similar training methodology has the aim of instructing a machine to understand how the maps, i.e. the memory cells present in the electronic control units (ECU), are distributed.

For this activity it is essential to provide this information to the artificial intelligence created using appropriate algorithms.

The process applied to the ECU therefore aims to analyze the software functions present within the control unit itself with the aim of obtaining the information useful for correctly instructing the existing artificial intelligence.

Therefore, it represents a fundamental process to adequately understand the main functions of the control unit, i.e. collect information relating to the contents of the memory maps (which are nothing more than matrices whose contents vary depending on the matrix of interest), that the redesign of the same in order to facilitate the tuning work.

At the same time, the choice of using intelligent algorithms allows to create an intelligent system suitable to “make decisions” and in this case the application concerns the recognition, by this intelligent network, of tables and maps contained within of the ECU. In this way the intelligent network may recognize the vehicle, extrapolate from the ECU the data resulting from the reading of the map to modify them and at the same time to show the various parameters examined in a suitable graphic interface.

The technique according to the present invention may be implemented within software tools used for data collection and processing in the ECU and using AI/ML solutions.

The technique according to the present invention will also be suitable to allow the selection of the optimal ECU, allowing the number of potentially suitable ECUs to be reduced, also allowing the preparation of data during the ECU matching phase.

The data provided for each file will contain a in-depth description of the contents of the binary file and the related ECU/vehicle.

An intrinsic metadata consists of:
ECU brand and family;
ECU data organization;
Brand, model, engine and fuel type of the vehicle;
Type of control unit.

This metadata is crucial for map categorization as part of filtering and clustering training data.

A high-quality filtered training set for narrow categories allows for better localized categorization.

Another mechanism applied to improve training results and reduce dataset size is constant detection and elimination of duplicates. To this end, data cleaning represents an important step in machine learning to increase the quality of map classification.

The training and testing step revealed that for some maps it is difficult to make a classification based only on the similarity score with a limited set of examples. The context, for example the ECU brand, the ECU family and the correct identification of the data organization, are crucial for the classification results.

To increase the accuracy of classification, the research has focused on the exploration of maps and axes of context and surroundings using the perceptual hash method.

To this end a proprietary hash function is used to detect:
data organization
ECU brand
ECU family

Based on the approach used in previous heuristics, a proprietary characteristic value reduction function has been developed which is used as the basis of the perceptual hash used to detect the ECU family, ECU brand and ECU type.

Process optimization of the algorithm's meta-parameters resulted in a perceptual hash that is both generalizing and sensitive to small differences between similar ECU families.

During the hash tuning process over 145 mappings in the training set were reported as mislabeled. This would not have been possible without a high-quality perceptual hash function.

The main goal of the AI/ML solution is to identify and classify map regions or other specific parts of binary files of the firmware with high accuracy using training examples provided by experts.

To achieve this, such a solution, like any AI/ML-based solution, consists of several parts that must be implemented to achieve valid results.

A first step involves data acquisition where a training data set must be provided to the system with the ability to modify and visualize the features. This part of the system is implemented using a web tool where each map can be edited, labeled and displayed. After verification, the data is sent to the Storage manager which performs the data cleaning step, as it is essential for any machine learning approach that the training data is 100% valid.

Using the technique allows you to check input data for the most common errors. Such inconsistencies are automatically delivered to data scientists and are an important factor in maintaining high-quality data processing and analysis, performed using specialized tools,

The advantages obtainable with the approach described above consist in particular in the creation of a map editor having a much lower learning curve and providing results with greater quality and efficiency.

The automatically discovered maps are more complete than most solutions available on the market and are checked for inconsistencies, so they have better quality than manually defined and error-prone solutions.

Every time a new example for a specific ECU is added to the database, the system develops a new and improved classification system without additional human effort, automating the map editing process.

The capacity to provide numerous examples for the same brand/model of vehicle allows the system to manage variations of both original and already modified files;

existing solutions on the market are limited only to the original factory maps.

1-9. (canceled)

10. A method for categorizing binary executable files comprising the following steps:
a) analyzing input and training data files for containing semi-organized, partially monotonic sequences;
b) determining whether to discard or accept potential sequences based upon preset statistical criteria in a preprocessing step;
c) encoding the accepted sequences with metadata;
d) storing the encoded sequences, wherein the sequences are stored as part of a data sequences digest containing information describing the spatial organization of sequences, the monotonicity features thereof and other features valuable for approximate matching; and
e) computing locality-sensitive hashes corresponding to input and training data files.

11. The method of claim 10, wherein the sequences are common in binary files in lookup tables, dictionaries, data-set indexes.

12. The method of claim 10, wherein the relative positions, length, and other sections of the sequences are used for calculating similarity.

13. The method of claim 11, wherein the relative positions, length, and other sections of the sequences are used for calculating similarity.

14. The method of claim 10, wherein the locality-sensitive hash is calculated based on at least one of wavelets and means for data compression.

15. The method of claim 11, wherein the locality-sensitive hash is calculated based on at least one of wavelets and means for data compression.

16. The method of claim 12, wherein the locality-sensitive hash is calculated based on at least one of wavelets and means for data compression.

17. The method of claim 13, wherein the locality-sensitive hash is calculated based on at least one of wavelets and means for data compression.

18. The method of claim 10, wherein the most significant parameters of data compression are encoded with single bits to reduce data digest to a 64-bit hash for fast Hamming distance calculation.

19. The method of claim 17, wherein the most significant parameters of data compression are encoded with single bits to reduce data digest to a 64-bit hash for fast Hamming distance calculation.

20. The method of claim 10, wherein a step for resolving potential collisions is provided by using an edit distance of sequences data digests.

21. The method of claim 11, wherein a step for resolving potential collisions is provided by using an edit distance of sequences data digests.

22. The method of claim 12, wherein a step for resolving potential collisions is provided by using an edit distance of sequences data digests.

23. The method of claim 13, wherein a step for resolving potential collisions is provided by using an edit distance of sequences data digests.

24. The method of claim 14, wherein a step for resolving potential collisions is provided by using an edit distance of sequences data digests.

25. The method of claim 15, wherein a step for resolving potential collisions is provided by using an edit distance of sequences data digests.

26. The method of claim 17, wherein a step for resolving potential collisions is provided by using an edit distance of sequences data digests.

27. The method of claim 19, wherein a step for resolving potential collisions is provided by using an edit distance of sequences data digests.

28. A method for training a vehicle electronic control unit (ECU) using artificial intelligence/machine learning algorithms, wherein said algorithms use a categorization technique of executable binary files, the method comprising:
a) analyzing input and training data files for containing semi-organized, partially monotonic sequences;
b) determining whether to discard or accept potential sequences based upon preset statistical criteria in a preprocessing step;
c) encoding the accepted sequences with metadata;
d) storing the encoded sequences, wherein the sequences are stored as part of a data sequences digest containing information describing the spatial organization of sequences, the monotonicity features thereof and other features valuable for approximate matching; and
e) computing locality-sensitive hashes corresponding to input and training data files.

29. A vehicle electronic control unit (ECU) trained according to the method of claim 10.
